(19) United States
(12) Patent Application Publication
(10) Pub. No.: US 2015/0091517 A1
(43) Pub. Date: Apr. 2, 2015

(54) CHARGING STATION, METHOD, AND ELECTRICALLY POWERED VEHICLE FOR THE WIRELESS ENERGY-TRANSFER COUPLING OF AN ELECTRICALLY POWERED VEHICLE

(71) Applicant: SIEMENS AKTIENGESELLSCHAFT, MUENCHEN (DE)

(72) Inventors: MANUEL BLUM, OTTOBRUNN (DE); THOMAS KOMMA, OTTOBRUNN (DE); MIRJAM MANTEL, MUENCHEN (DE); MONIKA POEBL, MUENCHEN (DE)

(21) Appl. No.: 14/499,430

(22) Filed: Sep. 29, 2014

(30) Foreign Application Priority Data
Sep. 27, 2013 (DE) 102013219536.2

(51) Int. Cl. B60L 11/18

(52) U.S. Cl. CPC B60L 11/182
USPC 320/108

(57) ABSTRACT

A charging station for wireless energy-transfer coupling of an electrically powered vehicle has a terminal for an electrical energy source and an electronic coil that generates an alternating magnetic field. The electronic coil has a cylindrical winding and a ferromagnetic body. A front face of the winding abuts against the ferromagnetic body in order to couple the alternating magnetic field issuing from the winding via the front face into the ferromagnetic body. The winding has a first winding and a second winding which are arranged next to one another and with their front faces abutting against the ferromagnetic body. The two windings generate an opposing alternating magnetic field. A space encompassed by the first and second windings respectively contains a ferromagnetic material.

### CROSS-REFERENCE TO RELATED APPLICATION

This application claims the priority, under 35 U.S.C. §119, of German patent application DE 10 2013 219 536.2, filed Sep. 27, 2013; the prior application is herewith incorporated by reference in its entirety.

### BACKGROUND OF THE INVENTION

### Field of the Invention

The present invention relates to a charging station for the wireless energy-transferring coupling of an electrically powered vehicle. The charging station comprises a terminal for an electrical energy source and an electronic coil via which an alternating magnetic field can be provided for the wireless energy transfer coupling of the electrically powered vehicle. The electronic coil has a cylindrical winding and a ferromagnetic body, the front face of the winding abutting against the ferromagnetic body in order to couple the alternating magnetic field issuing from the winding into the ferromagnetic body via the front face.

The invention relates further to a method for the wireless energy-transfer coupling of an electrically powered vehicle to a charging station which draws electrical energy from an electrical energy source and provides energy via an alternating magnetic field for the wireless energy-transferring coupling of the electrically powered vehicle. The alternating magnetic field is generated via an electronic coil of the charging station having a cylindrical winding and a ferromagnetic body, the alternating magnetic field issuing from the winding being coupled into the ferromagnetic body via a front face of the winding abutting against the ferromagnetic body.

Lastly, the invention relates also to an electrically powered vehicle for wireless energy-transferring coupling to a charging station, comprising an electrical energy storage device, a drive unit comprising an electric machine and an electronic coil which an alternating magnetic field of the charging station can suffuse for the wireless energy-transferring coupling of the charging station, the electronic coil having a cylindrical winding and a ferromagnetic body, a front face of the winding abutting against the ferromagnetic body in order to couple the alternating magnetic field issuing from the winding into the ferromagnetic body.

Charging stations and electrically powered vehicles of the generic type and methods for the operation thereof for wirelessly transferring energy by means of an alternating magnetic field are known in principle, so separate verification in printed publications is not required for these. Charging stations of the generic type are used for supplying an electrically powered vehicle with energy during a charging operation so that the electrically powered vehicle can perform its intended function. The electrically powered vehicle needs the energy in particular for propulsion.

The energy is provided by means of the alternating magnetic field of the charging station, which for its part is connected to an electrical energy source, for example to a public energy supply network, to an electric generator, to a battery and/or similar. The charging station generates the alternating magnetic field while receiving electrical energy from the electrical energy source. The electrically powered vehicle captures the alternating magnetic field by means of a suitable electronic coil, draws energy from it and provides electrical energy on the vehicle side, in particular in order to supply electrical energy to an electrical energy storage device of the vehicle and/or an electric machine of a drive apparatus of the vehicle.

One way of feeding the energy from the charging station to the charging device of the vehicle is to establish an electrical connection as an energy-transferring coupling by means of a cable between the vehicle and the charging station. In addition, it is known, according to a further option, for a wireless energy-transferring coupling to be established that avoids the need for a complex mechanical connection via cable. To this end, a coil circuit with an electronic coil is usually provided on the charging-station side and on the vehicle side, respectively, which coil circuits are arranged during a charging process substantially opposite one another and, using an alternating magnetic field, make an energy-transferring coupling possible. Such an arrangement is described, for example, in Korean published patent application KR 10 2012 0 016 521 A.

Coils for the intended use in a charging station as well as in a dual manner for the electrically powered vehicle should be constructed as flat as possible, so in the prior art the coils normally have a low structural height relative to their diameter. The coils are therefore simply placed with one of their two front faces on a ferrite body that is substantially rectangular in structure. The ferrite body forms a magnetic return. As a rule, the ratio of an inner diameter of the winding of the coil to its structural height in the direction of the alternating magnetic field is five-to-one or greater.

Given this configuration, the prevailing view in the prior art is that, due to the low structural height, a space encompassed by the winding should not be filled with a ferromagnetic material. For this reason, the space is usually a blank space filled with air.

Even though this structure has proven successful in the prior art, there is nonetheless a need for improvement, especially in view of more stringent requirements for the wireless energy-transferring coupling of the electrically powered vehicle.

### SUMMARY OF THE INVENTION

It is accordingly an object of the invention to provide a charging station, a charging method, and an electrically powered vehicle, which overcome the disadvantages of the heretofore-known devices of this general type and which provide for a system with an improved charging station in terms of its efficiency and effectiveness.

With the above and other objects in view there is provided, in accordance with the invention, a charging station for the wireless energy-transfer coupling of an electrically powered vehicle, the charging station comprising:

an electronic coil connected to a terminal for an electrical energy source and configured to generate an alternating magnetic field for the wireless energy-transfer coupling of the electrically powered vehicle;

the electronic coil including:
a ferromagnetic body;
first and second cylindrical windings each having a front face abutting against said ferromagnetic body for coupling the alternating magnetic field issuing from each said winding into said ferromagnetic body;
said first and second cylindrical windings being disposed next to one another and generating an opposing alternating magnetic field; and
ferromagnetic material disposed in a space respectively encompassed by said first and second cylindrical windings.

With the above and other objects in view there is also provided, in accordance with the invention, a method for the wireless energy-transfer coupling of an electrically powered vehicle to a charging station connected to an electrical energy source. The novel method comprises:

providing an electronic coil with a ferromagnetic body, first and second cylindrical windings disposed next to one another and having front faces abutting against the ferromagnetic body, and a ferromagnetic material disposed a space encompassed by the first and second windings, respectively;

generating with the first and second windings opposing alternating magnetic fields;

coupling the alternating magnetic field issuing from the windings into the ferromagnetic body via the front faces of the windings abutting against the ferromagnetic body; and

wirelessly transferring energy between the charging station and the electrically powered vehicle by way of the alternating magnetic field.

On the device side, the invention proposes in particular that the winding has a first and a second winding which are arranged next to one another and with their front faces abutting against the ferromagnetic body and which are designed to generate an opposing alternating magnetic field, a space encompassed between the first and the second winding respectively containing a ferromagnetic material. On the method side, it is proposed correspondingly that the winding generates opposing alternating magnetic fields by means of a first and a second winding which are arranged next to one another and with their front faces abutting against the ferromagnetic body, a space encompassed between the first and the second winding respectively using a ferromagnetic material.

Surprisingly, it has been found that the effectiveness of the wireless energy-transferring coupling can be improved considerably if the space encompassed by the winding is filled at least in part with a ferromagnetic material, even though the structural height of the winding is small relative to its diameter. It has in particular been shown that, surprisingly, a leakage flux from the winding—contrary to what has been assumed to date in the prior art—is not inconsiderable and can be reduced substantially by such a design according to the invention. In addition, this design allows a further reduction in unwanted self-heating of the winding due to electromagnetic interaction. Overall, not only can the degree of efficiency of the wireless energy-transferring coupling be improved, but unwanted power loss generation and consequently heat generation can also be reduced in this way. All in all, this results in an improved charging station that, relative to a comparable state-of-the-art charging station is more powerful, more compact and consequently also more cost-effective.

The invention therefore provides that the winding is divided into two subwindings, namely the first winding and the second winding. The two windings are arranged next to one another, for example at a predefinable distance from one another, or similar. This alone allows the structural height to be reduced. The winding, both the first winding and the second winding, is cylindrical in structure, having, for example, a rounded or else an angular base. The base of the cylinder formed by the winding may be rectangular, for example. However, combinations may also be provided, having both rounded and angular sections.

A direction of winding of the first and of the second turn and an electric current flowing through the first winding and the second winding are chosen such that, in terms of spatial orientation, the direction of the alternating magnetic field of the first winding is essentially opposite to the direction of the alternating magnetic field of the second winding. In this way, by means of the ferromagnetic body which may consist, for example, of a ferrite plate or similar, a magnetic circuit is produced which may be closed via a coil arrangement of the electrically powered vehicle. This enables a highly efficient transfer of energy from the charging station to the electrically powered vehicle in a compact design.

Inductive energy transfer or wireless energy-transferring coupling within the meaning of the invention is a coupling for the purpose of transferring energy which makes it possible to transfer energy at least unidirectionally from an energy source to an energy sink. The energy source may, for example, be a public energy supply network, an electric generator, a solar cell, a fuel cell, a battery, combinations thereof and/or similar. The energy sink may, for example, be a drive apparatus of the electrically powered vehicle, in particular an electric machine of the drive apparatus and/or an electrical energy storage device of the drive apparatus, for example an accumulator or similar. However, bidirectional energy transfer may also be provided, i.e. energy transfer alternately in both directions. This purpose is served by, among other things, the charging station, which is designed to transfer energy to the electrically powered vehicle, for which purpose it draws electrical energy from the energy source to which it is electrically connected.

Wireless energy-transferring coupling or inductive energy transfer within the meaning of the invention means that no mechanical connection needs to be provided between the charging station and the electrically powered vehicle in order to establish an electrical coupling. In particular, the establishment of an electrical connection by means of a cable can be avoided. Instead, the energy-transferring coupling is realized essentially solely on the basis of an energy field, preferably the alternating magnetic field.

The charging station is therefore configured to generate such an energy field, namely the alternating magnetic field. It is correspondingly provided on the vehicle side that the energy field or alternating magnetic field can be captured and energy obtained therefrom for operation of the electrically powered vehicle in its intended application. By means of the charging device of the vehicle, the energy supplied by means of the energy field, in particular the alternating magnetic field, is converted into electrical energy which can then be stored preferably in the energy storage device of the vehicle for the operation thereof as intended. For this purpose, the charging device may have a converter, which converts the electrical energy taken by means of the coil from the alternating magnetic field and fed to the converter into a form of electrical energy suitable for the vehicle, for example rectifies it, transforms its voltage or similar. In addition, the energy may also be fed directly to the electric machine of the drive apparatus of the vehicle. The energy-transferring coupling thus essentially serves the purpose of transferring energy, and not primarily of transferring information. Accordingly, the means for implementing the invention are, unlike a wireless communication connection, designed for a correspondingly high power throughput.

A key element for the wireless energy-transferring coupling, in particular by means of the alternating magnetic field, is the electronic coil, which may sometimes also consist of a plurality of electronic coils, which on the charging-station side serves to generate the alternating magnetic field and on the vehicle side is suffused by the alternating magnetic field and on the vehicle side provides electrical energy at its corresponding terminals. Correspondingly, on the charging-station side, an alternating voltage giving rise to an alternating current is applied to the electronic coil such that the electronic coil provides the alternating magnetic field by means of which energy can be emitted. Via the alternating magnetic field, the electronic coil of the charging station is coupled to the electronic coil of the electrically powered vehicle during the charging process.

The coil usually has a winding comprising several turns of an electrical conductor. A ferromagnetic body is also provided as a magnetic return. By means of the ferromagnetic body, the magnetic flux can be guided in a desired manner such that the effectiveness of the energy-transferring coupling can be increased on the basis of the alternating magnetic field between the coil circuits of the charging station and of the electrically powered vehicle.

The electrical conductor forming the turns of the electronic coil is frequently embodied as a so-called high-frequency litz wire, i.e. it consists of a plurality of individual conductors or wires electrically insulated from one another, which are combined in an appropriate manner to form the conductor. The result of this is that in frequency applications such as in the case of the invention, a current displacement effect is reduced or substantially prevented. In order to be able to improve as even as possible a distribution of current between the individual wires of the high-frequency litz wire, a twisting of the individual wires is usually also provided. The twisting may also include forming bundles of a certain number of individual wires which are in themselves twisted, and then likewise twisting these bundles to form the electrical conductor.

The ferromagnetic body may be composed of a ferrite material, a bundle of laminations or similar. The same also applies to the ferromagnetic material. In a particularly advantageous embodiment, the ferromagnetic material can be fashioned in one piece with the ferromagnetic body. It may, however, also be provided that the ferromagnetic body and the ferromagnetic material are assembled in a modular manner from multiple individual components. This design proves advantageous, for example, where large dimensions have to be achieved with the ferromagnetic body and the ferromagnetic material. In this way, modular components which are cost-effective to produce can be assembled so as to form the desired ferromagnetic body and the ferromagnetic material. This is particularly advantageous where sintered materials such as ferrite or similar are used, which are comparatively complex to produce in large dimensions.

According to a further aspect, it is proposed that the charging station has a first and a second inverter, the first winding being connected to the first inverter and the second winding being connected to the second inverter. This design has the advantage that the first winding and the second winding can be operated independently of one another. In this way, it is possible to achieve additional effects in terms of the magnetic field and the efficiency. It also proves particularly advantageous if the first winding and the second winding are electrically separated from one another, i.e. electrically insulated from one another. The first and the second winding can in this way be electrically controlled more easily, because the first and the second inverter can also be electrically separated from one another.

A further embodiment of the invention provides that the first and the second inverter are configured to apply an alternating electric voltage to the first and the second winding respectively, such that the alternating magnetic fields of the first and the second winding, said fields being coupled into the ferromagnetic body, are positively superimposed on one another. Positively superimpose means that a magnitude of the resulting magnetic field strength due to the superimposition is greater than a magnitude of the magnetic flux density which is generated by the first or the second winding. It proves particularly advantageous if the alternating magnetic fields of the first and the second winding are superimposed on one another such that the magnetic flux densities generated by the first and the second winding are added to one another.

It is proposed furthermore that the charging station has a control unit for the synchronized control of the first and of the second inverter. This creates the possibility for controlling the first and the second inverters in combination in such a way that a predefined desired effect can be achieved in the ferromagnetic body and/or in relation to the wireless energy-transferring coupling. Furthermore, by means of the control unit, a predefinable desired state can be controlled on the basis of a reference value such that distortions which may arise during normal operation can be corrected.

An advantageous further development provides that the first inverter is configured so as to be operated as a master and the second inverter is configured so as to be operated as a slave. The first and the second inverters are preferably in communication connection with one another, for example via a communication bus such as a CAN BUS, a communication network, combinations thereof, or similar. In this embodiment, there is thus a communication coupling between the first and the second inverter, the first inverter giving an appropriate control signal for the second inverter. Based upon the control signal given, the second inverter in slave mode adjusts the provision of the electrical alternating voltage for the second winding.

Alternatively, it can also be provided that the first and the second inverter are in communication connection with one another and can coordinate their operation with one another with regard to the preferably predefinable generation of the alternating magnetic field. In this case, a master-slave mode is not provided, rather the two inverters mutually adjust their operation to one another. To this end, it may be provided that the first and the second inverter exchange operating parameters, such as for example electric currents, electric voltages, phase positions in relation thereto, temperatures, combinations thereof, or similar.

It may additionally be provided that at least one sensor is available for the control unit or also for the first inverter being operated as a master, with which sensor a parameter determining the alternating magnetic field can be recorded in order to be able to generate control signals on this basis.

It is furthermore proposed that each of the first and the second winding has an alternating electric voltage applied to it by a first and a second inverter respectively. In a particularly advantageous embodiment, the two alternating voltages are galvanically separated from one another. This enables an embodiment which allows a particularly large amount of scope for maneuver in terms of the design.

A further embodiment of the invention provides that the inverters are operated in such a manner that a predefined phase shift is achieved between electric currents in the first and in the second winding. The predefined phase shift may be useful, for example because of tolerances and/or special operating conditions. The predefined phase shift may for example also be predefined as a reference value which, with the aid of the control unit, is used to control the first and the second inverter appropriately.

Other features which are considered as characteristic for the invention are set forth in the appended claims.

Although the invention is illustrated and described herein as embodied in charging station for the wireless energy-transferring coupling of an electrically powered vehicle and an associated method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows an electronic coil for a charging station according to the invention in a schematic sectional representation, the coil having two windings which have an alternating electric voltage applied to them jointly by a single inverter; and

FIG. 2 shows an electronic coil in a schematic sectional representation as in FIG. 1, the coil having likewise two windings which, however, in contrast to FIG. 1, have an alternating electric voltage applied to them by a first and a second inverter respectively.

### DETAILED DESCRIPTION OF THE INVENTION

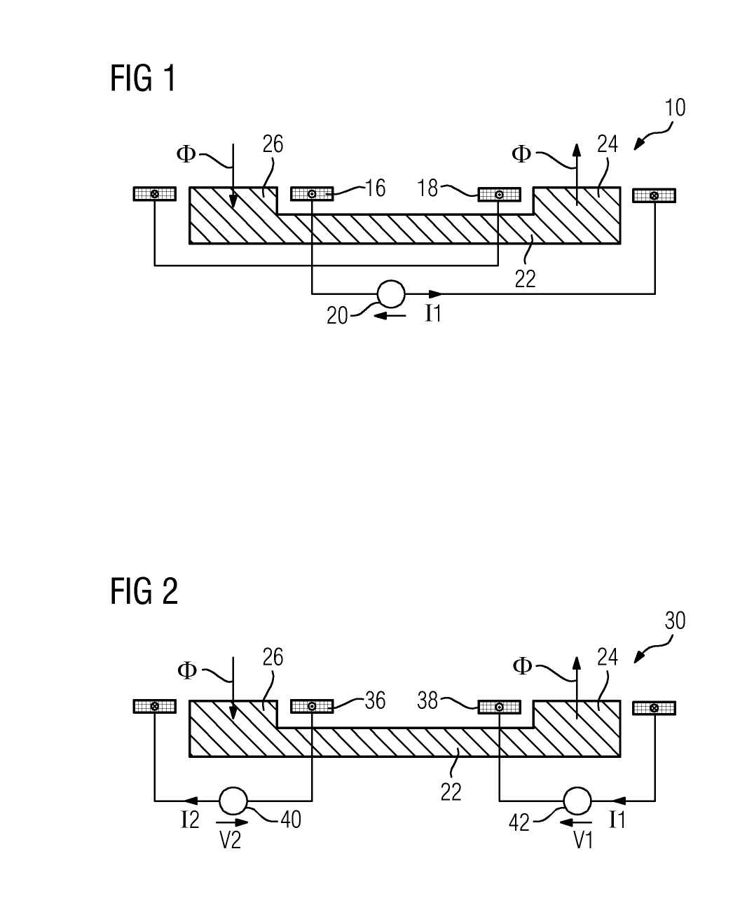

Referring now to the figures of the drawing in detail and first, particularly, to FIG. 1 thereof, there is shown a schematic sectional representation of a first electronic coil 10 according to the invention for a charging station for the wireless energy-transferring coupling of an electrically powered vehicle by way of an alternating magnetic field Φ. For this purpose, the charging station has a terminal for an electrical energy source, which in the present case consists of a public energy supply network. The alternating magnetic field Φ for the wireless energy-transferring coupling of the electrically powered vehicle can be provided by means of the electronic coil 10.

Additional detail regarding the charging station and the coupling of the electrically powered vehicle is found in our copending patent applications Nos. [docket numbers] 2013P15943, 2013P15947, 2013P15949, and 2013P15952, which are incorporated by reference herein.

The electronic coil 10 has a cylindrical winding which here comprises a first winding 16 and a second winding 18. The first winding 16 and the second winding 18 have a diameter which in the present embodiment is approximately 10 times greater than a height of the winding 16, 18. The height of the winding is a linear measurement in the direction of the alternating magnetic field Φ which is generated with the respective winding 16, 18.

The electronic coil 10 has furthermore a ferromagnetic body 22, which in the present case consists of a ferrite material. A front face (not labeled) of the windings 16, 18 abuts against the ferromagnetic body 22. As a result, the alternating magnetic field Φ issuing from the windings 16, 18 can couple via the front face into the ferromagnetic body 22.

The first winding 16 and the second winding 18 are arranged next to one another with their front faces abutting against the ferromagnetic body 22. Furthermore, they are fashioned such that they generate an opposing alternating magnetic field Φ, for which purpose the windings 16, 18 are fashioned appropriately in terms of direction of winding and winding current and have currents applied to them. In the present case, the windings 16, 18 are formed by multiple turns of an electrical conductor. However, it may also be provided that the windings 16, 18 each have only a single turn. It may additionally be provided that the windings 16, 18 may also have different numbers of turns and conductor cross-sections.

In the embodiment according to FIG. 1, the windings 16, 18 are connected to one another in series. In that case, the same alternating current flows through both windings 16, 18. The series circuit comprising the windings 16, 18 is connected to an inverter 20 which applies an alternating electric voltage V1 to the windings 16, 18. Consequently, the current I1 flows through the windings 16, 18.

In FIG. 1 it can further be seen that a space enclosed by the windings 16, 18 is filled by a ferromagnetic material 24, 26. The ferromagnetic material 24, 26 in this embodiment is preferably fashioned in one piece with the ferromagnetic body 22. It can also be seen from FIG. 1 that the ferromagnetic material 24, 26 lies substantially flush with the respective winding 16, 18. A uniform surface is preferably formed as a result. The alternating magnetic field Φ for the wireless energy-transferring coupling of the electrically powered vehicle is provided via this surface.

FIG. 2 shows a modification of the exemplary embodiment according to FIG. 1. The primary difference relative to the exemplary embodiment of FIG. 1 is that an electronic coil 30 is formed which has two windings 36, 38 that are driven differently. The windings are again—as in the exemplary embodiment in FIG. 1—arranged with their front faces abutting against a ferromagnetic body 22. In the case of the windings 36, 38, too, the space enclosed in each case is filled by a ferromagnetic material, for which reason the reader is additionally referred here to the comments on FIG. 1.

In contrast to FIG. 1, however, the windings 36, 38 are electrically insulated from one another and are each connected to their own inverter and have an alternating electric voltage V1, V2 applied by said respective inverter, namely the first inverter 40 and the second inverter 42. As a result, a current I2 flows in the first winding 36, whereas a current I1 flows in the second winding 38. This embodiment makes it possible, through appropriate control of the first and the second inverter 40, 42 to create additional control options for generating the alternating magnetic field Φ.

The preceding exemplary embodiments are intended merely to illustrate the invention and not to restrict it. Of course, a person skilled in the art will provide appropriate variations if required without departing from the core idea of the invention. The invention may, of course, in a dual manner also be applied in the case of an electronic coil of the electrically powered vehicle, which coil is provided there for the wireless energy-transferring coupling. The features specified in relation to the charging station may consequently also be applied in the case of an electrically powered vehicle.

Individual features may, of course, also be combined with one another in any way as required. In addition, device features may, of course, also be indicated by corresponding process steps and vice versa.

1. A charging station for the wireless energy-transfer coupling of an electrically powered vehicle, the charging station comprising:
an electronic coil connected to a terminal for an electrical energy source and configured to generate an alternating magnetic field for the wireless energy-transfer coupling of the electrically powered vehicle;
said electronic coil having:
a ferromagnetic body;
first and second cylindrical windings each having a front face abutting against said ferromagnetic body for coupling the alternating magnetic field issuing from each said winding into said ferromagnetic body;
said first and second cylindrical windings being disposed next to one another and generating an opposing alternating magnetic field; and
ferromagnetic material disposed in a space respectively encompassed by said first and second cylindrical windings.

2. The charging station according to claim 1, wherein said ferromagnetic material and said ferromagnetic body are integrally formed in one piece.

3. The charging station according to claim 1, comprising a first inverter connected to said first winding and a second inverter connected to said second winding.

4. The charging station according to claim 3, wherein said first and second inverter are configured to apply an alternating electric voltage to said first and second windings respectively, to cause the alternating magnetic fields generated by said first and second windings and coupled into said ferromagnetic body to be positively superimposed on one another.

5. The charging station according to claim 3, further comprising a control unit for a synchronized control of said first and second inverters.

6. The charging station according to claim 3, wherein said first inverter is configured to be operated as a master and said second inverter is configured to be operated as a slave.

7. The charging station according to claim 1, comprising an inverter for driving said first and second windings, and wherein said first and second windings are connected in series.

8. A method for the wireless energy-transfer coupling of an electrically powered vehicle to a charging station connected to an electrical energy source, the method comprising:
providing an electronic coil with a ferromagnetic body, first and second cylindrical windings disposed next to one another and having front faces abutting against the ferromagnetic body, and a ferromagnetic material disposed a space encompassed by the first and second windings, respectively;
generating with the first and second windings opposing alternating magnetic fields;
coupling the alternating magnetic field issuing from the windings into the ferromagnetic body via the front faces of the windings abutting against the ferromagnetic body; and
wirelessly transferring energy between the charging station and the electrically powered vehicle by way of the alternating magnetic field.

9. The method according to claim 8, which comprises applying to each of the first and second windings an alternating electric voltage by respective first and second inverters.

10. The method according to claim 9, which comprises operating the first and second inverters in synchronous operation.

11. The method according to claim 9, which comprises operating the first inverter as a master and operating the second inverter as a slave.

12. The method according to claim 9, which comprises operating the inverters so that a predefined phase shift is achieved between electric currents in the first and second winding.

13. An electrically powered vehicle for wireless energy-transfer coupling to a charging station, the vehicle comprising:
an electrical energy storage device;
a drive mechanism with an electric motor and an electronic coil to be suffused by an alternating magnetic field of the charging station for the wireless energy-transfer coupling of the charging station;
said electronic coil having a cylindrical winding with a front face abutting against a ferromagnetic body for coupling the alternating magnetic field issuing from the winding via the front face into the ferromagnetic body;
said cylindrical winding having first and second windings disposed next to one another and being configured to generate an opposing alternating magnetic field; and
a ferromagnetic material disposed in a space encompassed by said first and second windings respectively.
